(19) United States
(12) Patent Application Publication
(10) Pub. No.: US 2026/0101327 A1
(43) Pub. Date: Apr. 9, 2026

(54) MULTI-MODAL CONFIGURATION INFORMATION FOR MULTI-MODAL FLOW GROUPS

(71) Applicant: QUALCOMM Incorporated, San Diego, CA (US)

(72) Inventors: Sitaramanjaneyulu KANAMARLAPUDI, San Diego, CA (US); Prasada Veera Reddy KADIRI, San Diego, CA (US); Diana MAAMARI, San Diego, CA (US); Hyun Yong LEE, San Diego, CA (US); Mickaël MONDET, Louannec (FR); Sebastian SPEICHER, Wallisellen (CH)

(21) Appl. No.: 19/319,312

(22) Filed: Sep. 4, 2025

Related U.S. Application Data
(60) Provisional application No. 63/702,893, filed on Oct. 3, 2024.

(51) Int. Cl. H04W 72/12; H04W 28/02

(52) U.S. Cl. CPC H04W 72/12; H04W 28/0268

(57) ABSTRACT

Various aspects of the present disclosure generally relate to wireless communication. In some aspects, a user equipment (UE) may identify multi-modal configuration information that indicates one or more of: a multi-modal service identifier (MMSID); a multi-modal flow group associated with the MMSID; one or more flow-specific characteristics associated with the MMSID; or an inter-flow synchronization associated with the MMSID. The UE may transmit the multi-modal configuration information. Numerous other aspects are described.

### CROSS-REFERENCE TO RELATED APPLICATION

This Patent Application claims priority to U.S. Provisional Patent Application No. 63/702,893, filed on Oct. 3, 2024, entitled “MULTI-MODAL CONFIGURATION INFORMATION FOR MULTI-MODAL FLOW GROUPS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with multi-modal configuration information for multi-modal flow groups.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some implementations, an apparatus for wireless communication at a user equipment (UE) includes one or more memories; and one or more processors, coupled to the one or more memories, individually or collectively configured to cause the UE to: identify multi-modal configuration information that indicates one or more of: a multi-modal service identifier (MMSID); a multi-modal flow group associated with the MMSID; one or more flow-specific characteristics associated with the MMSID; or an inter-flow synchronization associated with the MMSID; and transmit the multi-modal configuration information.

In some implementations, an apparatus for wireless communication at a network node includes one or more memories; and one or more processors, coupled to the one or more memories, individually or collectively configured to cause the network node to: receive a multi-modal configuration information that indicates one or more of: an MMSID; a multi-modal flow group associated with the MMSID; one or more flow-specific characteristics associated with the MMSID; or an inter-flow synchronization associated with the MMSID; and perform a scheduling based at least in part on the multi-modal configuration information.

In some implementations, a method of wireless communication performed by a UE includes identifying multi-modal configuration information that indicates one or more of: an MMSID; a multi-modal flow group associated with the MMSID; one or more flow-specific characteristics associated with the MMSID; or an inter-flow synchronization associated with the MMSID; and transmitting the multi-modal configuration information.

In some implementations, a method of wireless communication performed by a network node includes receiving a multi-modal configuration information that indicates one or more of: an MMSID; a multi-modal flow group associated with the MMSID; one or more flow-specific characteristics associated with the MMSID; or an inter-flow synchronization associated with the MMSID; and performing a scheduling based at least in part on the multi-modal configuration information.

In some implementations, a non-transitory computer-readable medium storing a set of instructions for wireless communication includes one or more instructions that, when executed by one or more processors of a UE, cause the UE to: identify multi-modal configuration information that indicates one or more of: an MMSID; a multi-modal flow group associated with the MMSID; one or more flow-specific characteristics associated with the MMSID; or an inter-flow synchronization associated with the MMSID; and transmit the multi-modal configuration information.

In some implementations, a non-transitory computer-readable medium storing a set of instructions for wireless communication includes one or more instructions that, when executed by one or more processors of a network node, cause the network node to: receive a multi-modal configuration information that indicates one or more of: an MMSID; a multi-modal flow group associated with the MMSID; one or more flow-specific characteristics associated with the MMSID; or an inter-flow synchronization associated with the MMSID; and perform a scheduling based at least in part on the multi-modal configuration information.

In some implementations, an apparatus for wireless communication includes means for identifying multi-modal configuration information that indicates one or more of: an MMSID; a multi-modal flow group associated with the MMSID; one or more flow-specific characteristics associated with the MMSID; or an inter-flow synchronization associated with the MMSID; and means for transmitting the multi-modal configuration information.

In some implementations, an apparatus for wireless communication includes means for receiving a multi-modal configuration information that indicates one or more of: an MMSID; a multi-modal flow group associated with the MMSID; one or more flow-specific characteristics associated with the MMSID; or an inter-flow synchronization associated with the MMSID; and means for performing a scheduling based at least in part on the multi-modal configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated base station architecture, in accordance with the present disclosure.

FIG. 3 is a diagram illustrating an example of an immersive multi-modal extended reality (XR) application with a user equipment (UE) connected to an application server via a network node, in accordance with the present disclosure.

FIG. 4 is a diagram illustrating an example of synchronization requirements for multi-modality, in accordance with the present disclosure.

FIG. 5 is a diagram illustrating an example associated with multi-modal configuration information for multi-modal flow groups, in accordance with the present disclosure.

FIG. 6 is a flowchart illustrating an example process performed, for example, by a UE, in accordance with the present disclosure.

FIG. 7 is a flowchart illustrating an example process performed, for example, by a network node, in accordance with the present disclosure.

FIGS. 8-9 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a multi-modal interactive system, a variety of multi-modality input may be provided to different services in order to create an immersive extended reality (XR) experience. The multi-modality input may include biometric data from voice, words from voice, emotion from voice, biometric data from face, emotion from face, mouth movement, emotion from wearables, gestures, relative location, ambient information, and/or haptic information from wearables. Some multi-modality inputs may involve information from a user, whereas other multi-modality inputs may involve information from an environment. The different services may be associated with biometric recognition, intention perception, and/or service presence. The different services may produce a multi-modality output. The multi-modality output may include haptic feedback, brightness, sensible temperature, video, and/or audio.

In an immersive multi-modal XR application, a user may interact with virtual entities in a virtual environment, such that a perception of interaction with a real physical world may be achieved. The user may perceive multiple senses (e.g., vision, sound, and/or touch) for full immersion in the virtual environment. A degree of immersion achieved may indicate a level of realness associated with the virtual environment. Since users are fairly sensitive when using immersive multi-modal XR applications, a small error in a preparation of the virtual environment may be noticed. A high-field virtual environment (high-resolution images and three-dimensional stereo audio) may be needed to achieve a fully immersive experience.

In a multi-modality operation, a set of flows may be configured for coordinated scheduling, discard, and/or delay budget restrictions. The set of flows may include a first flow and a second flow. The first flow may be associated with a packet data unit (PDU) set integrity handling indicator (PSIHI) level 1 and a PDU set delay budget (PSDB) 1. The second flow may be associated with a PSIHI level 2 and a PSDB 2. For the first flow, PSIHI level 1 may indicate that all packets in a PDU set are to be delivered. When one packet in the PDU set is lost, then all of the packets in the PDU set are to be discarded (not delivered). PSDB 1 may be defined as 50 ms. For the second flow, PSIHI level 2 may indicate that not all packets in the PDU set are required to be delivered. Even when one or two packets are lost in the PDU set, remaining packets of the PDU set may still be delivered because even a partial PDU set delivery may be useful to an application. PSDB 2 may be defined as 20 ms. The first flow and the second flow may be part of a multi-modal operation with latency, PSIHI, and/or error rates that are defined in a flow-specific manner, which may result in an immersive experience when the first flow and the second flow are played together for a given application.

When the first flow loses one or two packets in the PDU set, all packets in the PDU set are to be discarded based on a definition of the PSIHI level 1. The second flow may not lose any packets or may lose an acceptable number of packets, so by definition, the packets associated with the second flow may be delivered. However, when the second flow is associated with the first flow as part of a multi-modal flow group, all packets in the second flow should also be discarded in conjunction with the first flow. For example, the first flow may be associated with video, and the second flow may be associated with audio, so when all video packets in the first flow are discarded, associated audio packets in the second flow should also be discarded. In some cases, the second flow may be unknown to be associated with the first flow. In other words, the first flow and the second flow may not be known to be part of the same multi-modal flow group, which may be due to a lack of knowledge of associations between flows of a multi-modal service. The association between the flows of the multi-modal service may not be conveyed for the flows on a given bearer or PDU session. When the association between the first flow and the second flow is not known, the packets for the first flow (e.g., video) may be discarded but the packets for the second flow (e.g., audio associated with the video) may still be delivered. In this example, delivering the audio without the corresponding video may degrade an immersive experience, thereby degrading an overall system performance.

Various aspects relate generally to multi-modal configuration information. Some aspects more specifically relate to multi-modal configuration information for multi-modal flow groups. In some examples, a UE may identify multi-modal configuration information. The multi-modal configuration information may indicate a multi-modal service identifier (MMSID). The multi-modal configuration information may indicate a multi-modal flow group associated with the MMSID. The multi-modal configuration information may indicate one or more flow-specific characteristics associated with the MMSID. The multi-modal configuration information may indicate an inter-flow synchronization associated with the MMSID. The UE may transmit the multi-modal configuration information to a network node. The network node may be part of a radio access network (RAN). The network node may perform a scheduling based at least in part on the multi-modal configuration information. As part of the scheduling, the network node may map different multi-modal quality of service (QoS) flows, of the MMSID, to a same data radio bearer (DRB) based at least in part on the multi-modal configuration information. The network node may allocate a number of grants to satisfy a PDU set delay budget. The network node may discard packets based at least in part on an association between the different multi-modal QoS flows. The network node may ensure an error rate across the different multi-modal QoS flows is within a limit.

Particular aspects of the subject matter described in this disclosure can be implemented to realize one or more of the following potential advantages. In some examples, by providing the multi-modal configuration information, the described techniques can be used to allow the network node to become aware of associations between different flows of a multi-modal service. The network node may obtain information regarding the MMSID and the multi-modal flow group associated with the MMSID. The network node may obtain information regarding the one or more flow-specific characteristics associated with the MMSID. The network node may obtain information regarding the inter-flow synchronization associated with the MMSID. The network node may use such information when implementing a RAN scheduling. For example, the network node may map related but different multi-modal QoS flows to the same DRB. The network node may allocate a sufficient number of grants to satisfy the PDU set delay budget. The network node may discard packets of one flow when an associated flow is also discarded. For example, by utilizing the multi-modal configuration information, the network node may become aware of related QoS flows, so when one QoS flow is to be discarded, the network node may also discard the related QoS flow. As a result, when performing the RAN scheduling, the network node may utilize the multi-modal configuration information to achieve a more realistic immersive experience (e.g., synchronized audio and video), thereby improving an overall system performance.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

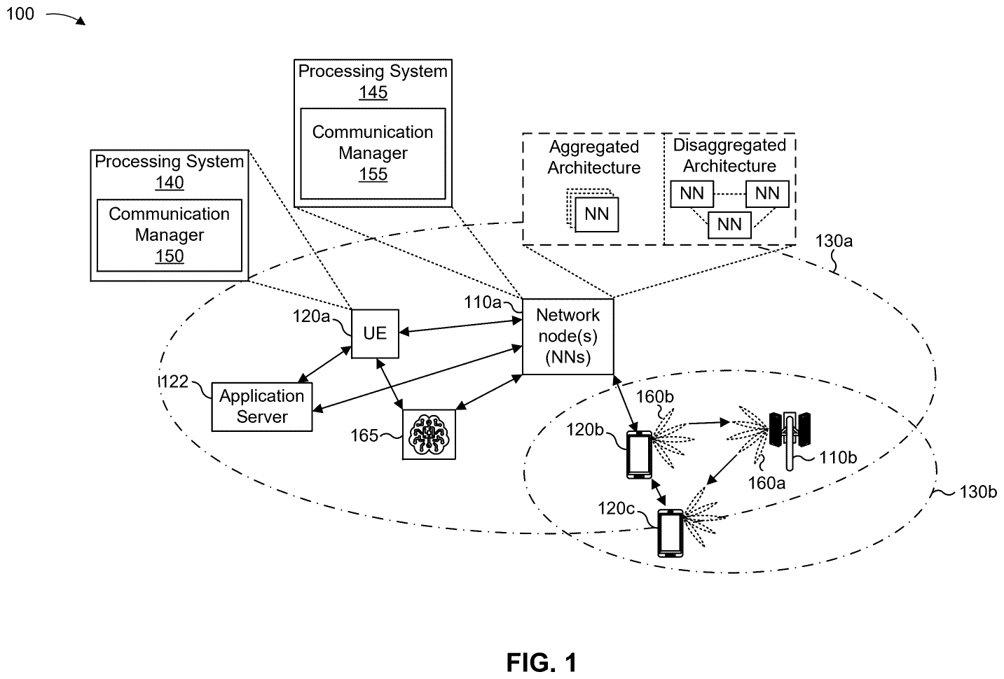

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

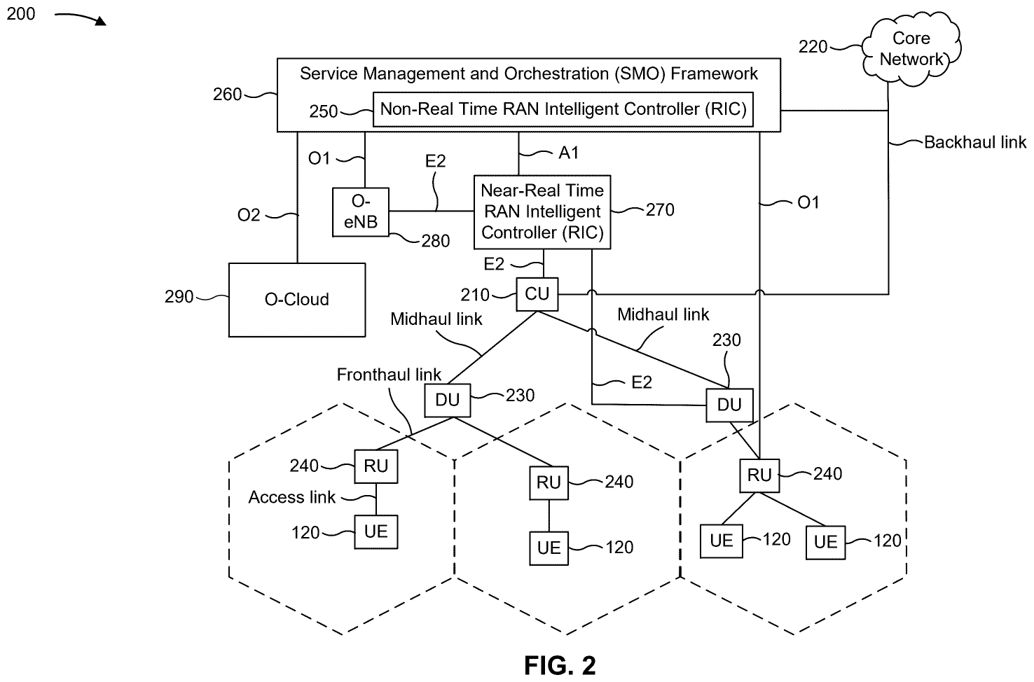

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE (e.g., the UE 120) may include a communication manager 150. As described in more detail elsewhere herein, the communication manager 150 may identify multi-modal configuration information that indicates one or more of: an MMSID; a multi-modal flow group associated with the MMSID; one or more flow-specific characteristics associated with the MMSID; or an inter-flow synchronization associated with the MMSID; and transmit the multi-modal configuration information. Additionally, or alternatively, the communication manager 150 may perform one or more other operations described herein.

In some aspects, a network node (e.g., the network node 110) may include a communication manager 155. As described in more detail elsewhere herein, the communication manager 155 may receive a multi-modal configuration information that indicates one or more of: an MMSID; a multi-modal flow group associated with the MMSID; one or more flow-specific characteristics associated with the MMSID; or an inter-flow synchronization associated with the MMSID; and perform a scheduling based at least in part on the multi-modal configuration information. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

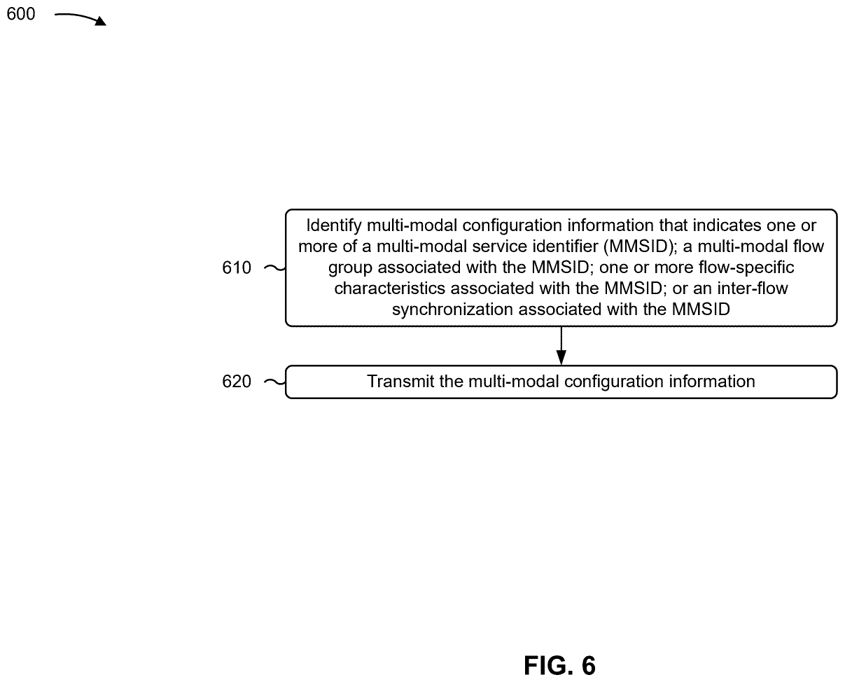

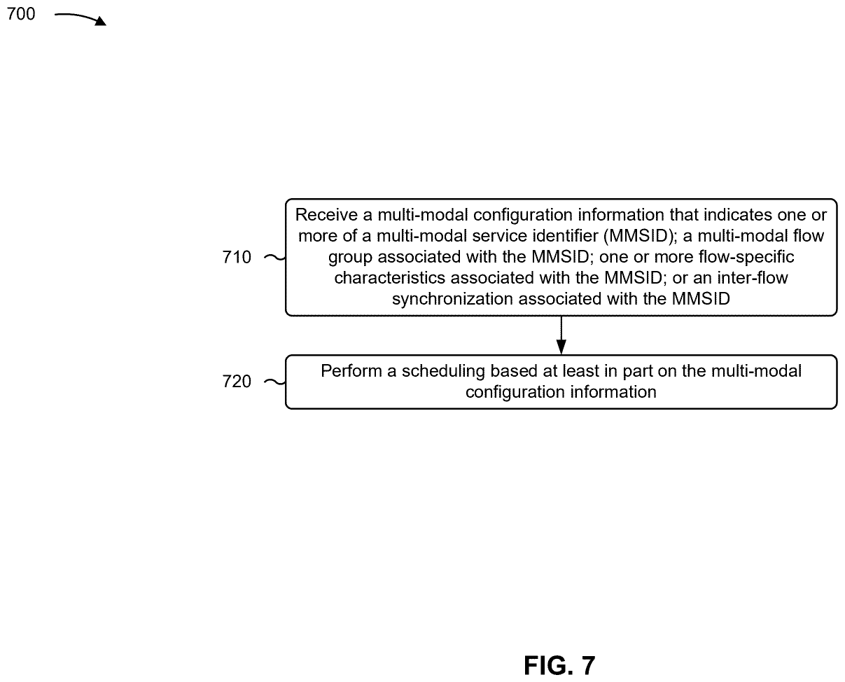

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with multi-modal configuration information for multi-modal flow groups, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

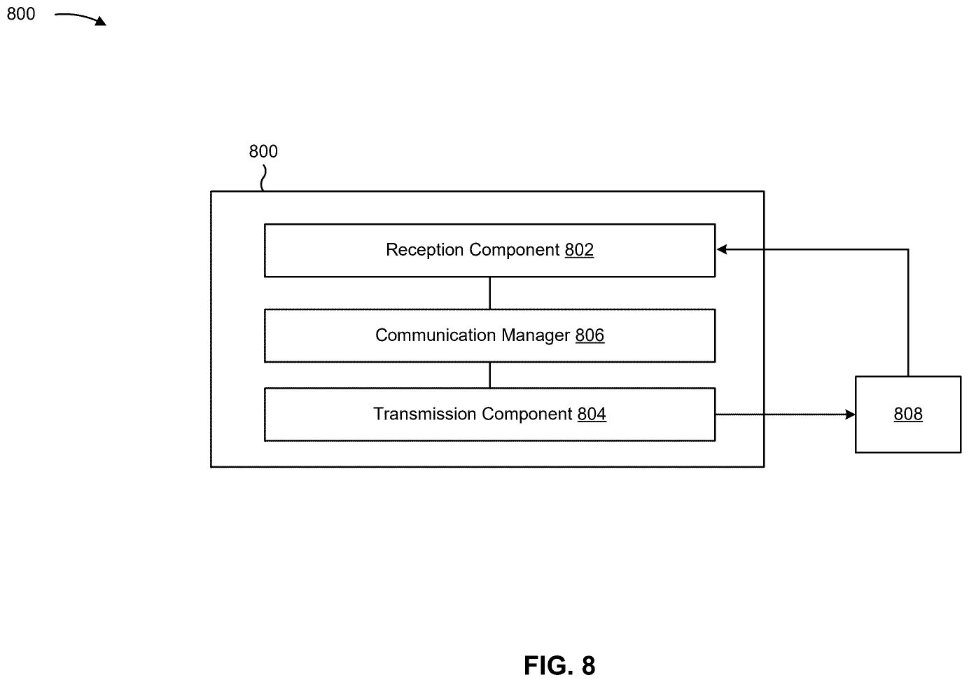

In some aspects, a UE (e.g., the UE 120) includes means for identifying multi-modal configuration information that indicates one or more of: an MMSID; a multi-modal flow group associated with the MMSID; one or more flow-specific characteristics associated with the MMSID; and/or an inter-flow synchronization associated with the MMSID; and/or means for transmitting the multi-modal configuration information. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

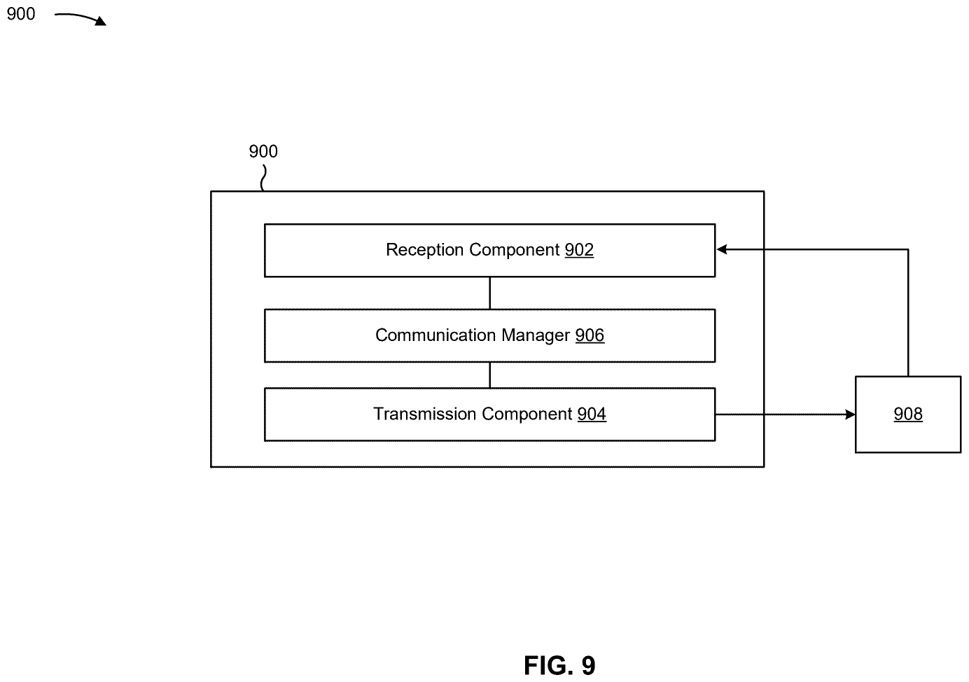

In some aspects, the network node includes means for receiving a multi-modal configuration information that indicates one or more of: an MMSID; a multi-modal flow group associated with the MMSID; one or more flow-specific characteristics associated with the MMSID; and/or an inter-flow synchronization associated with the MMSID; and/or means for performing a scheduling based at least in part on the multi-modal configuration information. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

As indicated above, FIG. 2 is provided as an example. Other examples may differ from what is described with regard to FIG. 2.

A UE (e.g., UE 120) may support one or more XR functionalities. For example, the UE may be an XR device or may be associated with an XR device. For example, the UE may be connected to the XR device via a wired connection and/or a wireless connection. The wired connection may be a universal serial bus (USB) connection or a serial advanced technology attachment (SATA) connection. The wireless connection may be a Bluetooth, Wi-Fi, or 5G connection. XR functionalities may include augmented reality (AR), virtual reality (VR), or mixed reality (MR), among other examples. For example, when providing an XR service, the UE may provide rendered data via a display (such as a screen), a set of VR goggles, a heads-up display, or another type of display. The XR device may be an AR glasses device, a VR glasses device, or other gaming device.

The XR functionalities may be supported by an application server. The application server may host an application, such as a gaming application, a video streaming application, an XR application, a VR application, an AR application, and/or another type of application for which communication flows of streaming data are provided between the UE and the application server, between an XR device and the application server, and/or between the application server and another device in a wireless communication network. The application may consume data using PDU sets rather than IP packets. A PDU set may be a set of IP packets representing a unit of information at the application. The application server may be included in an edge server, a cloud environment, and/or another type of server environment. The UE and/or an XR device may execute an application client associated with the application hosted by the application server, such as a gaming application client, a video streaming application client, an XR application client, a VR application client, an AR application client, and/or another type of application client.

In a multi-modal interactive system, a variety of multi-modality input may be provided to different services in order to create an immersive XR experience. The multi-modality input may include biometric data from voice, words from voice, emotion from voice, biometric data from face, emotion from face, mouth movement, emotion from wearables, gestures, relative location, ambient information, and/or haptic information from wearables. Some multi-modality inputs may involve information from a user, whereas other multi-modality inputs may involve information from an environment. The different services may be associated with biometric recognition, intention perception (e.g., multi-modality natural language processing (NLP), multi-modality emotion, and/or multi-modality haptic), and/or service presence (e.g., audio/video service, and/or IoT control). The different services may produce a multi-modality output. The multi-modality output may include haptic feedback, brightness, sensible temperature, video, and/or audio.

The multi-modality input and the multi-modality output may be referred to as multi-modal data. Multi-modal data may be input data from different kinds of devices/sensors or output data to different kinds of destinations (e.g., one or more UEs) required for the same task or application. Multi-modal data may include more than one single-modal data and with strong dependency among each single-modal data. Single-modal data may correspond to one type of data. Multi-modal data may be associated with a multi-modal synchronization threshold. The multi-modal synchronization threshold may be maximum tolerable temporal separation of an onset of two stimuli, where one stimuli is presented to one sense and another stimuli is presented to another sense, such that accompanying sensory objects are perceived as being synchronous. The multi-modal interactive system may be provided over a tactile Internet. The tactile Internet may be a network (or network of networks) for remotely accessing, perceiving, manipulating, and/or controlling real or virtual objects or processes in perceived real time by humans or machines.

In an immersive multi-modal XR application, a user may interact with virtual entities in a virtual environment, such that a perception of interaction with a real physical world may be achieved. The user may perceive multiple senses (e.g., vision, sound, and/or touch) for full immersion in the virtual environment. A degree of immersion achieved may indicate a level of realness associated with the virtual environment. Since users are fairly sensitive when using immersive multi-modal XR applications, a small error in a preparation of the virtual environment may be noticed. A high-field virtual environment (high-resolution images and three-dimensional stereo audio) may be needed to achieve a fully immersive experience.

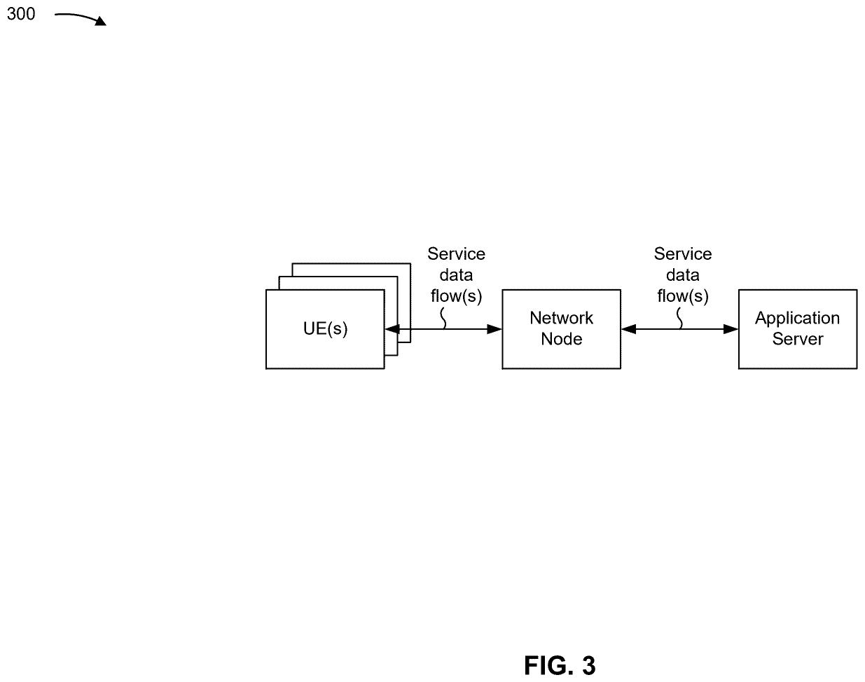

FIG. 3 is a diagram illustrating an example 300 of an immersive multi-modal XR application with a UE connected to an application server via a network node, in accordance with the present disclosure.

As shown in FIG. 3, the UE (e.g., VR glasses and/or gloves) may be connected to the application server via the network node. The UE may communicate with the application server via one or more service data flows. The UE may transmit haptic data and sensing data with different periodic times. As an example, the UE may transmit one packet containing haptic information to the application server every 2 milliseconds (ms), and the UE may transmit packets related to sensing information to the application server every 4 ms. The UE may transmit the haptic data and the sensing data via two separate flows. An amount of haptic packets that are generated and transferred within one second may be 1000 to 4000 packets (without haptic compression encoding), or 100 to 500 packets (with haptic compression encoding). A size of each haptic packet may be related to a degrees of freedom (DoF) capacity supported by the UE, where a data size for one DoF may be 2 to 8 bytes.

The application server may receive uplink data (e.g., the haptic data and/or the sensing data) from the UE. The application server may perform necessary process operations on an immersive reality, which may involve rendering and coding video and audio/haptic model data. The application server may periodically transmit downlink data to the UE. The application server may transmit the downlink data (e.g., haptic data and video/audio data) with different periodic time. For example, the application server may transmit one packet containing haptic information to the UE every 2 ms, and the application server may transmit packets related to one video/audio frame to the UE every 16.7 ms when 60 frames per second is implemented. Thus, the haptic data and the audio/video data may be transferred via two separate service data flows of a single session.

In some cases, to obtain more realistic and compelling virtual environments, network assistance may be needed to ensure synchronization thresholds between different modal data, which may serve to improve a user's sense of presence and realism. An immersive experience may be achieved by combining multiple inputs from the UE, and then rendering the multiple inputs together with close synchronization to ensure a virtual experience that is as close to reality as possible. Some traffic may be predictable (e.g., video with a frame periodicity) and some traffic may be unpredictable (e.g., sensing data). Different types of traffic may have different latency requirements as well as synchronization between inputs, where the inputs may be part of different devices connected to the UE.

As indicated above, FIG. 3 is provided as an example. Other examples may differ from what is described with regard to FIG. 3.

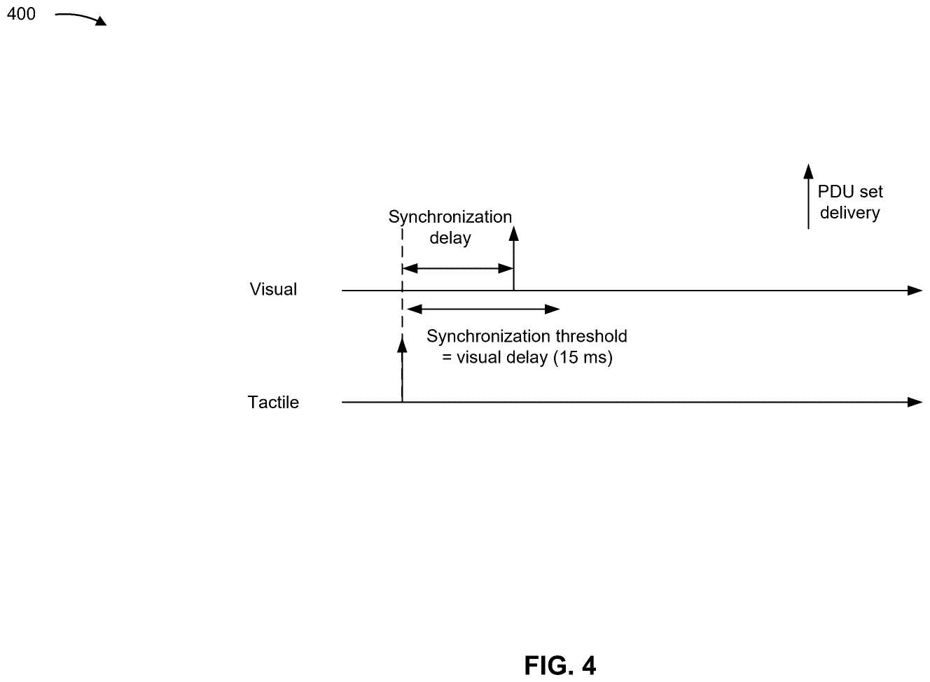

FIG. 4 is a diagram illustrating an example 400 of synchronization requirements for multi-modality, in accordance with the present disclosure.

Synchronization requirements may be specified for a multi-modal scenario. Audio, visual, and tactile flows may have different periodicities. Synchronization requirements may be specified between two flows (e.g., audio and tactile, or video and tactile). For an audio-tactile scenario, a synchronization threshold for an audio delay may be approximately 50 ms, and a synchronization threshold for a tactile delay may be approximately 25 ms. For a visual-tactile scenario, a synchronization threshold for a visual delay may be approximately 15 ms, and a synchronization threshold for a tactile delay may be approximately 50 ms. For each media component, “delay” may refer to the case in which that media component is delayed as compared to another media component.

As shown in FIG. 4, with multi-modality, multiple different flows (e.g., haptic and video) may be associated with the same (multi-modal) service in a single PDU session. PDU sets (or PDUs) from one traffic flow may need to be delivered within a synchronization threshold from a delivery of associated PDU sets (or PDUs) from a second traffic flow of the same multi-modal service. For example, a haptic packet should come no later than 15 ms from video packets. When the haptic packet (tactile) arrives earlier in time as compared to the video packets (visual), the associated video packets should be delivered within 15 ms in order to satisfy a synchronization threshold requirement.

In a multi-modality operation among a group of flows for coordinated scheduling, discard, and delay budget restrictions, information on an associated set of flows may be needed, where the associated set of flows may be in a single bearer or across bearers of a PDU session.

As indicated above, FIG. 4 is provided as an example. Other examples may differ from what is described with regard to FIG. 4.

In a multi-modality operation, a set of flows may be configured for coordinated scheduling, discard, and/or delay budget restrictions. The set of flows may include a first flow and a second flow. The first flow may be associated with a PSIHI level 1 and a PSDB 1. The second flow may be associated with a PSIHI level 2 and a PSDB 2. For the first flow, PSIHI level 1 may indicate that all packets in a PDU set are to be delivered. When one packet in the PDU set is lost, then all of the packets in the PDU set are to be discarded (not delivered). PSDB 1 may be defined as 50 ms. For the second flow, PSIHI level 2 may indicate that not all packets in the PDU set are required to be delivered. Even when one or two packets are lost in the PDU set, remaining packets of the PDU set may still be delivered because even a partial PDU set delivery may be useful to an application. PSDB 2 may be defined as 20 ms. The first flow and the second flow may be part of a multi-modal operation with latency, PSIHI, and/or error rates that are defined in a flow-specific manner, which may result in an immersive experience when the first flow and the second flow are played together for a given application.

When the first flow loses one or two packets in the PDU set, all packets in the PDU set are to be discarded based on a definition of the PSIHI level 1. The second flow may not lose any packets or may lose an acceptable number of packets, so by definition, the packets associated with the second flow may be delivered. However, when the second flow is associated with the first flow as part of a multi-modal flow group, all packets in the second flow should also be discarded in conjunction with the first flow. For example, the first flow may be associated with video and the second flow may be associated with audio, so when all video packets in the first flow are discarded, associated audio packets in the second flow should also be discarded. In some cases, the second flow may be unknown to be associated with the first flow. In other words, the first flow and the second flow may not be known to be part of the same multi-modal flow group, which may be due to a lack of knowledge of associations between flows of a multi-modal service. The association between the flows of the multi-modal service may not be conveyed for the flows on a given bearer or PDU session. When the association between the first flow and the second flow is not known, the packets for the first flow (e.g., video) may be discarded but the packets for the second flow (e.g., audio associated with the video) may still be delivered. In this example, delivering the audio without the corresponding video may degrade an immersive experience, thereby degrading an overall system performance.

In various aspects of techniques and apparatuses described herein, a UE may identify multi-modal configuration information. The multi-modal configuration information may indicate an MMSID. The multi-modal configuration information may indicate a multi-modal flow group associated with the MMSID. The multi-modal configuration information may indicate one or more flow-specific characteristics associated with the MMSID. The multi-modal configuration information may indicate an inter-flow synchronization associated with the MMSID. The UE may transmit the multi-modal configuration information to a network node associated with a RAN. The network node may be part of a RAN. The network node may perform a scheduling based at least in part on the multi-modal configuration information. As part of the scheduling, the network node may map different multi-modal QoS flows, of the MMSID, to a same DRB based at least in part on the multi-modal configuration information. The network node may allocate a number of grants to satisfy a PDU set delay budget. The network node may discard packets based at least in part on an association between the different multi-modal QoS flows. The network node may ensure an error rate across the different multi-modal QoS flows is within a limit.

In some aspects, the application server may provide multi-modality assistance information to a core network, such as a 5G core (5GC), which may forward the multi-modality assistance information to the RAN. When the application server and/or the 5GC does not provide the multi-modality assistance information to the RAN, the RAN may obtain the multi-modal configuration information from the UE via UE assistance information.

In some aspects, the UE may transmit, to the network node, the UE assistance information in accordance with a multi-modal flow definition, where the UE assistance information may be uplink RRC UE assistance information. The network node, via a RAN network scheduler, may use the UE assistance information to ensure optimal scheduling of needed flows of an MMSID within a delay budget. The network node, via the RAN network scheduler, may use the UE assistance information to discard certain packets when the packets are not needed from an MMSID perspective. The network node, via the RAN network scheduler, may use the UE assistance information to satisfy an overall error rate, which may ensure that an immersive user experience is delivered to the UE.

In some aspects, by providing the multi-modal configuration information, the network node may become aware of associations between different flows of a multi-modal service. The network node may obtain information regarding the MMSID and the multi-modal flow group associated with the MMSID. The network node may obtain information regarding the one or more flow-specific characteristics associated with the MMSID. The network node may obtain information regarding the inter-flow synchronization associated with the MMSID. The network node may use such information when implementing a RAN scheduling. For example, the network node may map related but different multi-modal QoS flows to the same DRB. The network node may allocate a sufficient number of grants to satisfy the PDU set delay budget. The network node may discard packets of one flow when an associated flow is also discarded. For example, by utilizing the multi-modal configuration information, the network node may become aware of related QoS flows, so when one QoS flow is to be discarded, the network node may also discard the related QoS flow (e.g., sending packets for the related QoS flow would unnecessarily increase a signaling overhead). As a result, when performing the RAN scheduling, the network node may utilize the multi-modal configuration information to achieve a more realistic immersive experience (e.g., synchronized audio and video), thereby improving an overall system performance.

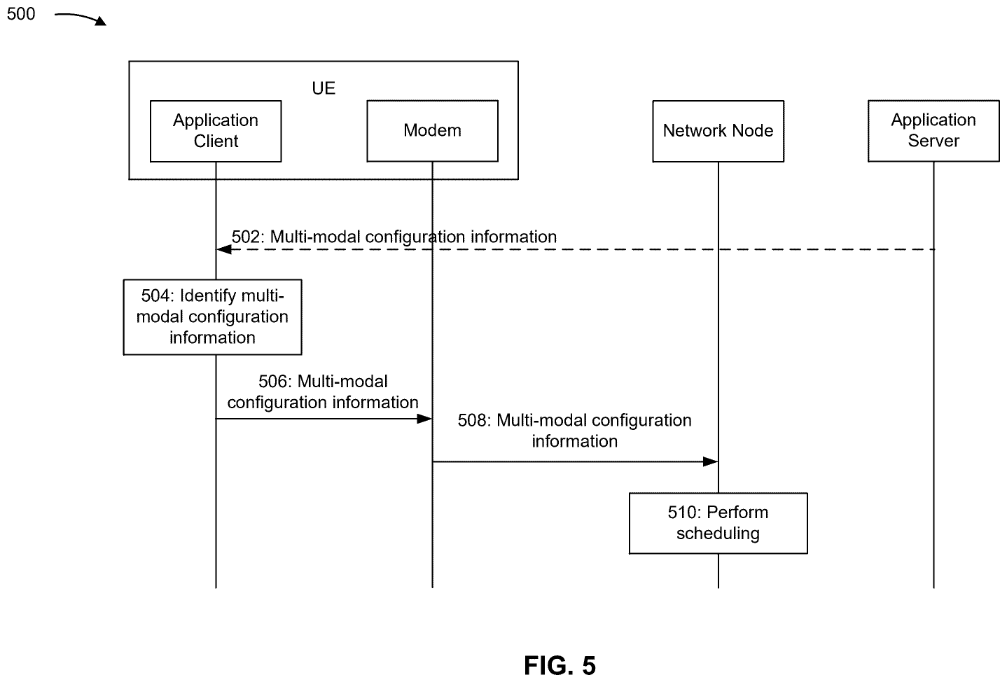

FIG. 5 is a diagram illustrating an example 500 associated with multi-modal configuration information for multi-modal flow groups, in accordance with the present disclosure. As shown in FIG. 5, example 500 includes communication between a UE (e.g., UE 120), a network node (e.g., network node 110), and an application server (e.g., application server 122). In some aspects, the UE, the network node, and the application server may be included in a wireless network, such as wireless network 100. The UE may include an application client and a modem. The network node may be associated with a RAN.

As shown by reference number 502, the application client may receive, from the application server, multi-modal configuration information. The application client may receive the multi-modal configuration information via application layer signaling or in-band signaling between the application client and the application server. Alternatively, the application client may not receive any multi-modal configuration information from the application server. In other words, receiving the multi-modal configuration information from the application server may be optional.

As shown by reference number 504, the application client may identify the multi-modal configuration information. The application client may identify the multi-modal configuration information based at least in part the application layer signaling or the in-band signaling between the application client and the application server. Alternatively, the application client may determine the multi-modal configuration information itself without assistance from the application server. The multi-modal configuration information may indicate an MMSID. The multi-modal configuration information may indicate a multi-modal flow group associated with the MMSID. The multi-modal configuration information may indicate one or more flow-specific characteristics associated with the MMSID. The multi-modal configuration information may indicate an inter-flow synchronization associated with the MMSID.

In some aspects, the multi-modal configuration information may include an indicator that indicates whether the multi-modal configuration information is associated with a full list of MMSIDs, an additional list of MMSIDs, or a removal list of MMSIDs. In some aspects, the multi-modal configuration information may indicate a plurality of MMSIDs, where the MMSID may be included in the plurality of MMSIDs and the MMSID may be associated with the multi-modal flow group. The multi-modal configuration information may indicate, for each MMSID in the plurality of MMSIDs, a plurality of QoS flows. The multi-modal configuration information may indicate, for each QoS flow in the plurality of QoS flows, the one or more flow-specific characteristics including a QoS flow identifier (QFI), QFI flow information that includes a flow direction, an uplink PDU set importance, and/or the inter-flow synchronization that includes a multi-modality synchronization threshold. The plurality of QoS flows may be associated with a single DRB, or the plurality of QoS flows may be across multiple DRBs. The MMSID may be associated with a DRB or the MMSID may be associated with a PDU session. In some aspects, the multi-modal configuration information may indicate, for each multi-modal flow group, an inter-flow synchronization threshold between PDU sets belonging to at least two or more multi-modal flows.

As shown by reference number 506, the application client may send the multi-modal configuration information to the modem. The application client may provide the multi-modal configuration information based at least in part on a cross layer application programming interface (API) between the application client and the modem.

As shown by reference number 508, the modem may transmit the multi-modal configuration information to the network node. The modem may transmit the multi-modal configuration information via UE assistance information. The UE assistance information may be RRC-based UE assistance information. Alternatively, the modem may transmit the multi-modal configuration information via a MAC-CE. The modem may use the MAC-CE to convey the multi-modal configuration information in accordance with a prohibit timer.

In some aspects, the UE may receive, from the network node, a request for multi-modal configuration information. The UE may transmit, to the network node, the multi-modal configuration information in response to the request. In some aspects, the UE may identify updated multi-modal configuration information based at least in part on an added MMSID, a modified MMSID, a deleted MMSID, or an updated multi-modal synchronization threshold. The UE may transmit, to the network node, the updated multi-modal configuration information.

As shown by reference number 510, the network node may perform a scheduling (e.g., a RAN scheduling) based at least in part on the multi-modal configuration information. As part of the scheduling, the network node may map different multi-modal QoS flows, of the MMSID, to a same DRB based at least in part on the multi-modal configuration information. The network node may allocate a number of grants to satisfy a PDU set delay budget. The network node may discard packets based at least in part on an association between the different multi-modal QoS flows. The network node may ensure an error rate across the different multi-modal QoS flows is within a limit.

In some aspects, the application client may identify the MMSID for at least one or more groups of associated multi-modal QoS flows. The application client may identify the multi-modality synchronization threshold among multi-modal QoS flows. The application client may generate the MMSID and/or the multi-modality synchronization threshold itself, or a network-side application server may provide the MMSID and/or the multi-modality synchronization threshold to the application client via application layer signaling or control plane signaling. The application client may provide the MMSID and/or the multi-modality synchronization threshold to the modem (e.g., Uu modem), for example, via the cross layer API. The modem may indicate, to the network node, UE assistance information that indicates the MMSID and the multi-modality synchronization threshold. The UE assistance information may be UE-assisted uplink multi-modal configuration information. The UE assistance information may be RRC-based UE assistance information. In some aspects, the MMSID and the multi-modality synchronization threshold may travel from the application server to the application client, and then to the modem, and then to the network node. Alternatively, the MMSID and the multi-modality synchronization threshold may originate at the application client, and then travel to the modem, and then to the network node. The network node may use the UE assistance information for scheduling. The network node may use the UE assistance information to drop or deliver PDU sets within one QoS flow in multi-modal relation traffic based at least in part on a relation between MMSIDs, which may ensure effective application traffic and an immersive experience for XR use cases.

In some aspects, the UE may convey the UE assistance information that indicates the MMSID and/or the multi-modality synchronization threshold. The UE may provide the MMSID and/or the multi-modality synchronization threshold to the RAN as assistance information for handling multi-modal traffic. The RAN may use the UE assistance information for mapping different multi-modal QoS flows to the same DRB. The UE may be associated with different MMSIDs representing different types of multi-modal QoS flows. The UE assistance information may carry various types of information at a UE level for uplink multi-modality. For each group of multi-modal QoS flows, the UE may provide the RAN with an inter-flow synchronization threshold between PDU sets belonging to at least two or more multi-modal QoS flows. The UE assistance information may indicate whether a configuration is a full configuration, an add configuration, or a remove configuration. In other words, the UE may indicate whether conveyed information corresponds to a full list, an additional list, or a removal list. The UE assistance information may indicate a number of MMSIDs. In other words, the UE assistance information may indicate a number of multi-modal flow groups that are present. The UE assistance information may indicate, for each MMSID, an identification of a multi-modal flow identifier and a number of QFI. The number of QFI may indicate a total number of QoS flows associated with that MMSID. The UE assistance information may indicate, for each QoS flow, QFI information of the flow (e.g., QoS flow identifier), an uplink PDU set importance, and/or the multi-modality synchronization threshold from at least one or more reference QoS flows. A reference QoS flow may be associated with a reference QoS flow identifier. The UE assistance information may provide information on all relevant MMSIDs at a given time, or the UE assistance information may only provide information on new MMSIDs.

In some aspects, the UE assistance information may indicate the MMSID, which may be an identifier of a multi-modal flow group. The UE assistance information may indicate a QFI and a direction of a corresponding QoS flow (e.g., uplink). The UE assistance information may indicate an associated multi-modality QoS flow, which may be a list of QFIs. The UE assistance information may indicate a multi-modal synchronization for each associated QFI to the QoS flow, where the multi-modal synchronization may be an integer value.

In some aspects, an uplink UE assistance information may be provided by the UE to the RAN based at least in part on an explicit request from the RAN. The UE assistance information may be updated on-demand when new MMSIDs are added, modified, and/or deleted. The UE assistance information may be updated on-demand when synchronization threshold values are updated.

In some aspects, the UE may convey the MMSID and/or the synchronization threshold via the MAC-CE. A prohibit timer may be configured, such that the UE cannot update the MMSID and/or the synchronization threshold before the prohibit timer expires. The MAC-CE may be triggered in the uplink direction based at least in part on one or more triggering conditions. For example, when a new higher priority QFI has been modified or added, the UE may be allowed to transmit the MAC-CE.

In some aspects, multi-modality may be supported in the RAN for an uplink direction and/or a downlink direction. When the MMSID is not available to the RAN from a core network, the UE assistance information may be utilized. The UE-assistance information may contain multi-modal information, which may include a multi-modal identifier, an association between QoS flows, and/or a synchronization requirement. Multi-modality association knowledge between the network node and the UE may be used for both the uplink direction and the downlink direction. The multi-modality association knowledge may increase capacity and/or improve power saving. The UE assistance information may be used for multi-modal awareness for uplink QoS flows and/or downlink QoS flows for XR applications. Coordinated handling of multi-modal QoS flows may be supported.

In some aspects, the UE may report, via the UE assistance information, an existence of a multi-modality application and association information among QFIs to the network node. The network node may perform a joint admission control based at least in part on the UE assistance information. The network node may use the UE assistance information during a QoS flow to DRB mapping, depending on a network node implementation. For a downlink, whether a traffic synchronization (on a per packet basis) is able to be achieved may depend on whether packet level synchronization information is able to be provided from the core network to the RAN. A PDU set discard across QoS flows of the same multi-modal service based at least in part on dependency information between multi-modal flows may be achieved when synchronization information is available at the UE. Traffic of different multi-modals having different QoS requirements may be mapped to different QoS flows. For different XR traffic flows associated with the same multi-modal service and having different QoS requirements, differentiated QoS handling may be provided over the air. The network node may determine a framework for mapping QoS flows to DRBs.

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure.

Example process 600 is an example where the apparatus or the UE (e.g., UE 120) performs operations associated with multi-modal configuration information for multi-modal flow groups.

As shown in FIG. 6, in some aspects, process 600 may include identifying multi-modal configuration information that indicates one or more of: an MMSID; a multi-modal flow group associated with the MMSID; one or more flow-specific characteristics associated with the MMSID; or an inter-flow synchronization associated with the MMSID (block 610). For example, the UE (e.g., using communication manager 806, depicted in FIG. 8) may identify multi-modal configuration information that indicates one or more of: an MMSID; a multi-modal flow group associated with the MMSID; one or more flow-specific characteristics associated with the MMSID; or an inter-flow synchronization associated with the MMSID, as described above.

As further shown in FIG. 6, in some aspects, process 600 may include transmitting the multi-modal configuration information (block 620). For example, the UE (e.g., using transmission component 804 and/or communication manager 806, depicted in FIG. 8) may transmit the multi-modal configuration information, as described above.

Process 600 may include additional aspects, such as any single aspect or any combination of aspects described below and/or in connection with one or more other processes described elsewhere herein.

In a first aspect, process 600 includes transmitting the multi-modal configuration information via UE assistance information.

In a second aspect, alone or in combination with the first aspect, process 600 includes identifying the multi-modal configuration information based at least in part on application layer signaling or in-band signaling between an application client of the UE and an application server.

In a third aspect, alone or in combination with one or more of the first and second aspects, the multi-modal configuration information includes an indicator that indicates whether the multi-modal configuration information is associated with a full list of MMSIDs, an additional list of MMSIDs, or a removal list of MMSIDs.

In a fourth aspect, alone or in combination with one or more of the first through third aspects, the multi-modal configuration information indicates a plurality of MMSIDs, wherein the MMSID is included in the plurality of MMSIDs and the MMSID is associated with the multi-modal flow group, for each MMSID in the plurality of MMSIDs, a plurality of QoS flows, and for each QoS flow in the plurality of QoS flows, the one or more flow-specific characteristics including a QFI, QFI flow information that includes a flow direction, an uplink PDU set importance, and the inter-flow synchronization that includes a multi-modality synchronization threshold.

In a fifth aspect, alone or in combination with one or more of the first through fourth aspects, the plurality of QoS flows are associated with a single DRB or the plurality of QoS flows are across multiple DRBs.

In a sixth aspect, alone or in combination with one or more of the first through fifth aspects, the MMSID is associated with a DRB or the MMSID is associated with a PDU session.

In a seventh aspect, alone or in combination with one or more of the first through sixth aspects, the multi-modal configuration information indicates, for each multi-modal flow group, an inter-flow synchronization threshold between PDU sets belonging to at least two or more multi-modal flows.

In an eighth aspect, alone or in combination with one or more of the first through seventh aspects, process 600 includes receiving a request for multi-modal configuration information, and transmitting the multi-modal configuration information in response to the request.

In a ninth aspect, alone or in combination with one or more of the first through eighth aspects, process 600 includes identifying updated multi-modal configuration information based at least in part on an added MMSID, a modified MMSID, a deleted MMSID, or an updated multi-modal synchronization threshold, and transmitting the updated multi-modal configuration information.

In a tenth aspect, alone or in combination with one or more of the first through ninth aspects, the multi-modal configuration information is associated with a RAN scheduling, and different multi-modal QoS flows are able to be mapped to a same DRB based at least in part on the multi-modal configuration information.

In an eleventh aspect, alone or in combination with one or more of the first through tenth aspects, process 600 includes transmitting the multi-modal configuration information via a MAC-CE and in accordance with a prohibit timer.

In a twelfth aspect, alone or in combination with one or more of the first through eleventh aspects, process 600 includes providing the multi-modal configuration information based at least in part on a cross layer API between an application client of the UE and a modem of the UE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with multi-modal configuration information for multi-modal flow groups.

As shown in FIG. 7, in some aspects, process 700 may include receiving a multi-modal configuration information that indicates one or more of: an MMSID; a multi-modal flow group associated with the MMSID; one or more flow-specific characteristics associated with the MMSID; or an inter-flow synchronization associated with the MMSID (block 710). For example, the network node (e.g., using reception component 902 and/or communication manager 906, depicted in FIG. 9) may receive a multi-modal configuration information that indicates one or more of: an MMSID; a multi-modal flow group associated with the MMSID; one or more flow-specific characteristics associated with the MMSID; or an inter-flow synchronization associated with the MMSID, as described above.

As further shown in FIG. 7, in some aspects, process 700 may include performing a scheduling based at least in part on the multi-modal configuration information (block 720). For example, the network node (e.g., using communication manager 906, depicted in FIG. 9) may perform a scheduling based at least in part on the multi-modal configuration information, as described above.

Process 700 may include additional aspects, such as any single aspect or any combination of aspects described below and/or in connection with one or more other processes described elsewhere herein.

In a first aspect, process 700 includes mapping different multi-modal QoS flows, of the MMSID, to a same DRB based at least in part on the multi-modal configuration information, allocating a number of grants to satisfy a PDU set delay budget, discarding packets based at least in part on an association between the different multi-modal QoS flows, or ensuring an error rate across the different multi-modal QoS flows is within a limit.

In a second aspect, alone or in combination with the first aspect, process 700 includes receiving the multi-modal configuration information via UE assistance information.

In a third aspect, alone or in combination with one or more of the first and second aspects, the multi-modal configuration information includes an indicator that indicates whether the multi-modal configuration information is associated with a full list of MMSIDs, an additional list of MMSIDs, or a removal list of MMSIDs.

In a fourth aspect, alone or in combination with one or more of the first through third aspects, the multi-modal configuration information indicates a plurality of MMSIDs, wherein the MMSID is included in the plurality of MMSIDs and the MMSID is associated with the multi-modal flow group, for each MMSID in the plurality of MMSIDs, a plurality of QoS flows, and for each QoS flow in the plurality of QoS flows, the one or more flow-specific characteristics including a QFI, QFI flow information that includes a flow direction, an uplink PDU set importance, and the inter-flow synchronization that includes a multi-modality synchronization threshold.

In a fifth aspect, alone or in combination with one or more of the first through fourth aspects, the plurality of QoS flows are associated with a single DRB or the plurality of QoS flows are across multiple DRBs.

In a sixth aspect, alone or in combination with one or more of the first through fifth aspects, the MMSID is associated with a DRB or the MMSID is associated with a PDU session.

In a seventh aspect, alone or in combination with one or more of the first through sixth aspects, the multi-modal configuration information indicates, for each multi-modal flow group, an inter-flow synchronization threshold between PDU sets belonging to at least two or more multi-modal flows.

In an eighth aspect, alone or in combination with one or more of the first through seventh aspects, process 700 includes transmitting a request for multi-modal configuration information, and receiving the multi-modal configuration information in response to the request.

In a ninth aspect, alone or in combination with one or more of the first through eighth aspects, process 700 includes receiving the multi-modal configuration information via a MAC-CE and in accordance with a prohibit timer.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may identify multi-modal configuration information that indicates one or more of an MMSID; a multi-modal flow group associated with the MMSID; one or more flow-specific characteristics associated with the MMSID; or an inter-flow synchronization associated with the MMSID. The transmission component 804 may transmit the multi-modal configuration information.

The communication manager 806 may identify the multi-modal configuration information based at least in part on application layer signaling or in-band signaling between an application client of the UE and an application server. The communication manager 806 may provide the multi-modal configuration information based at least in part on a cross layer API between an application client of the UE and a modem of the UE.

The reception component 802 may receive a request for multi-modal configuration information. The transmission component 804 may transmit the multi-modal configuration information in response to the request. The communication manager 806 may identify updated multi-modal configuration information based at least in part on an added MMSID, a modified MMSID, a deleted MMSID, or an updated multi-modal synchronization threshold. The transmission component 804 may transmit the updated multi-modal configuration information.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive a multi-modal configuration information that indicates one or more of an MMSID; a multi-modal flow group associated with the MMSID; one or more flow-specific characteristics associated with the MMSID; or an inter-flow synchronization associated with the MMSID. The communication manager 906 may perform a scheduling based at least in part on the multi-modal configuration information. The transmission component 904 may transmit a request for multi-modal configuration information. The reception component 902 may receive the multi-modal configuration information in response to the request.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: identifying multi-modal configuration information that indicates one or more of: a multi-modal service identifier (MMSID); a multi-modal flow group associated with the MMSID; one or more flow-specific characteristics associated with the MMSID; or an inter-flow synchronization associated with the MMSID; and transmitting the multi-modal configuration information.

Aspect 2: The method of Aspect 1, wherein the multi-modal configuration information is transmitted via UE assistance information.

Aspect 3: The method of any of Aspects 1-2, wherein identifying the multi-modal configuration information is based at least in part on application layer signaling or in-band signaling between an application client of the UE and an application server.

Aspect 4: The method of any of Aspects 1-3, wherein the multi-modal configuration information includes an indicator that indicates whether the multi-modal configuration information is associated with a full list of MMSIDs, an additional list of MMSIDs, or a removal list of MMSIDs.

Aspect 5: The method of any of Aspects 1-4, wherein the multi-modal configuration information indicates: a plurality of MMSIDs, wherein the MMSID is included in the plurality of MMSIDs and the MMSID is associated with the multi-modal flow group; for each MMSID in the plurality of MMSIDs, a plurality of quality of service (QoS) flows; and for each QoS flow in the plurality of QoS flows, the one or more flow-specific characteristics including a QoS flow identifier (QFI), QFI flow information that includes a flow direction, an uplink packet data unit (PDU) set importance, and the inter-flow synchronization that includes a multi-modality synchronization threshold.

Aspect 6: The method of Aspect 5, wherein the plurality of QoS flows are associated with a single data radio bearer (DRB) or the plurality of QoS flows are across multiple DRBs.

Aspect 7: The method of Aspect 5, wherein the MMSID is associated with a data radio bearer (DRB) or the MMSID is associated with a PDU session.

Aspect 8: The method of any of Aspects 1-7, wherein the multi-modal configuration information indicates, for each multi-modal flow group, an inter-flow synchronization threshold between packet data unit (PDU) sets belonging to at least two or more multi-modal flows.

Aspect 9: The method of any of Aspects 1-8, further comprising: receiving a request for multi-modal configuration information; and transmitting the multi-modal configuration information in response to the request.

Aspect 10: The method of any of Aspects 1-9, further comprising: identifying updated multi-modal configuration information based at least in part on an added MMSID, a modified MMSID, a deleted MMSID, or an updated multi-modal synchronization threshold; and transmitting the updated multi-modal configuration information.

Aspect 11: The method of any of Aspects 1-10, wherein the multi-modal configuration information is associated with a radio access network (RAN) scheduling, and wherein different multi-modal quality of service (QoS) flows are able to be mapped to a same data radio bearer (DRB) based at least in part on the multi-modal configuration information.

Aspect 12: The method of any of Aspects 1-11, wherein the multi-modal configuration information is transmitted via a medium access control control element (MAC-CE) and in accordance with a prohibit timer.

Aspect 13: The method of any of Aspects 1-12, further comprising: providing the multi-modal configuration information based at least in part on a cross layer application programming interface (API) between an application client of the UE and a modem of the UE.

Aspect 14: A method of wireless communication performed by a network node, comprising: receiving a multi-modal configuration information that indicates one or more of: a multi-modal service identifier (MMSID); a multi-modal flow group associated with the MMSID; one or more flow-specific characteristics associated with the MMSID; or an inter-flow synchronization associated with the MMSID; and performing a scheduling based at least in part on the multi-modal configuration information.

Aspect 15: The method of Aspect 14, wherein performing the scheduling comprises one or more of: mapping different multi-modal quality of service (QoS) flows, of the MMSID, to a same data radio bearer (DRB) based at least in part on the multi-modal configuration information; allocating a number of grants to satisfy a packet data unit (PDU) set delay budget; discarding packets based at least in part on an association between the different multi-modal QoS flows; or ensuring an error rate across the different multi-modal QoS flows is within a limit.

Aspect 16: The method of any of Aspects 14-15, wherein the multi-modal configuration information is received via user equipment (UE) assistance information.

Aspect 17: The method of any of Aspects 14-16, wherein the multi-modal configuration information includes an indicator that indicates whether the multi-modal configuration information is associated with a full list of MMSIDs, an additional list of MMSIDs, or a removal list of MMSIDs.

Aspect 18: The method of any of Aspects 14-17, wherein the multi-modal configuration information indicates: a plurality of MMSIDs, wherein the MMSID is included in the plurality of MMSIDs and the MMSID is associated with the multi-modal flow group; for each MMSID in the plurality of MMSIDs, a plurality of quality of service (QoS) flows; and for each QoS flow in the plurality of QoS flows, the one or more flow-specific characteristics including a QoS flow identifier (QFI), QFI flow information that includes a flow direction, an uplink packet data unit (PDU) set importance, and the inter-flow synchronization that includes a multi-modality synchronization threshold.

Aspect 19: The method of Aspect 18, wherein the plurality of QoS flows are associated with a single data radio bearer (DRB) or the plurality of QoS flows are across multiple DRBs.

Aspect 20: The method of Aspect 18, wherein the MMSID is associated with a data radio bearer (DRB) or the MMSID is associated with a PDU session.

Aspect 21: The method of any of Aspects 14-20, wherein the multi-modal configuration information indicates, for each multi-modal flow group, an inter-flow synchronization threshold between packet data unit (PDU) sets belonging to at least two or more multi-modal flows.

Aspect 22: The method of any of Aspects 14-21, further comprising: transmitting a request for multi-modal configuration information; and receiving the multi-modal configuration information in response to the request.

Aspect 23: The method of any of Aspects 14-22, wherein the multi-modal configuration information is received via a medium access control control element (MAC-CE) and in accordance with a prohibit timer.

Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-23.

Aspect 25: An apparatus for wireless communication at a device, the apparatus comprising one or more memories and one or more processors coupled to the one or more memories, the one or more processors configured to cause the device to perform the method of one or more of Aspects 1-23.

Aspect 26: An apparatus for wireless communication, the apparatus comprising at least one means for performing the method of one or more of Aspects 1-23.

Aspect 27: A non-transitory computer-readable medium storing code for wireless communication, the code comprising instructions executable by one or more processors to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

Aspect 29: A device for wireless communication, the device comprising a processing system that includes one or more processors and one or more memories coupled with the one or more processors, the processing system configured to cause the device to perform the method of one or more of Aspects 1-23.

Aspect 30: An apparatus for wireless communication at a device, the apparatus comprising one or more memories and one or more processors coupled to the one or more memories, the one or more processors individually or collectively configured to cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, individually or collectively configured to cause the UE to:
identify multi-modal configuration information that indicates one or more of:
a multi-modal service identifier (MMSID);
a multi-modal flow group associated with the MMSID;
one or more flow-specific characteristics associated with the MMSID; or
an inter-flow synchronization associated with the MMSID; and
transmit the multi-modal configuration information.

2. The apparatus of claim 1, wherein the multi-modal configuration information is transmitted via UE assistance information.

3. The apparatus of claim 1, wherein the one or more processors are configured to cause the UE to:
identify the multi-modal configuration information based at least in part on application layer signaling or in-band signaling between an application client of the UE and an application server.

4. The apparatus of claim 1, wherein the multi-modal configuration information includes an indicator that indicates whether the multi-modal configuration information is associated with a full list of MMSIDs, an additional list of MMSIDs, or a removal list of MMSIDs.

5. The apparatus of claim 1, wherein the multi-modal configuration information indicates:
a plurality of MMSIDs, wherein the MMSID is included in the plurality of MMSIDs and the MMSID is associated with the multi-modal flow group;
for each MMSID in the plurality of MMSIDs, a plurality of quality of service (QoS) flows; and
for each QoS flow in the plurality of QoS flows, the one or more flow-specific characteristics including a QoS flow identifier (QFI), QFI flow information that includes a flow direction, an uplink packet data unit (PDU) set importance, and the inter-flow synchronization that includes a multi-modality synchronization threshold.

6. The apparatus of claim 5, wherein the plurality of QoS flows are associated with a single data radio bearer (DRB) or the plurality of QoS flows are across multiple DRBs.

7. The apparatus of claim 5, wherein the MMSID is associated with a data radio bearer (DRB) or the MMSID is associated with a PDU session.

8. The apparatus of claim 1, wherein the multi-modal configuration information indicates, for each multi-modal flow group, an inter-flow synchronization threshold between packet data unit (PDU) sets belonging to at least two or more multi-modal flows.

9. The apparatus of claim 1, wherein the one or more processors are further configured to cause the UE to:
receive a request for multi-modal configuration information; and
transmit the multi-modal configuration information in response to the request.

10. The apparatus of claim 1, wherein the one or more processors are further configured to cause the UE to:
identify updated multi-modal configuration information based at least in part on an added MMSID, a modified MMSID, a deleted MMSID, or an updated multi-modal synchronization threshold; and
transmit the updated multi-modal configuration information.

11. The apparatus of claim 1, wherein the multi-modal configuration information is associated with a radio access network (RAN) scheduling, and wherein different multi-modal quality of service (QoS) flows are able to be mapped to a same data radio bearer (DRB) based at least in part on the multi-modal configuration information.

12. The apparatus of claim 1, wherein the multi-modal configuration information is received via a medium access control control element (MAC-CE) and in accordance with a prohibit timer.

13. The apparatus of claim 1, wherein the one or more processors are configured to cause the UE to:
provide the multi-modal configuration information based at least in part on a cross layer application programming interface (API) between an application client of the UE and a modem of the UE.

14. An apparatus for wireless communication at a network node, comprising:
one or more memories; and
one or more processors, coupled to the one or more memories, individually or collectively configured to cause the network node to:
receive a multi-modal configuration information that indicates one or more of:
a multi-modal service identifier (MMSID);
a multi-modal flow group associated with the MMSID;
one or more flow-specific characteristics associated with the MMSID; or
an inter-flow synchronization associated with the MMSID; and
perform a scheduling based at least in part on the multi-modal configuration information.

15. The apparatus of claim 14, wherein the one or more processors, to perform the scheduling, are configured to:
map different multi-modal quality of service (QoS) flows, of the MMSID, to a same data radio bearer (DRB) based at least in part on the multi-modal configuration information;
allocate a number of grants to satisfy a packet data unit (PDU) set delay budget;
discard packets based at least in part on an association between the different multi-modal QoS flows; or
ensure an error rate across the different multi-modal QoS flows is within a limit.

16. The apparatus of claim 14, wherein the multi-modal configuration information is received via user equipment (UE) assistance information.

17. The apparatus of claim 14, wherein the multi-modal configuration information includes an indicator that indicates whether the multi-modal configuration information is associated with a full list of MMSIDs, an additional list of MMSIDs, or a removal list of MMSIDs.

18. The apparatus of claim 14, wherein the multi-modal configuration information indicates:
a plurality of MMSIDs, wherein the MMSID is included in the plurality of MMSIDs and the MMSID is associated with the multi-modal flow group;
for each MMSID in the plurality of MMSIDs, a plurality of quality of service (QoS) flows; and
for each QoS flow in the plurality of QoS flows, the one or more flow-specific characteristics including a QoS flow identifier (QFI), QFI flow information that includes a flow direction, an uplink packet data unit (PDU) set importance, and the inter-flow synchronization that includes a multi-modality synchronization threshold.

19. The apparatus of claim 14, wherein the one or more processors are further configured to cause the network node to:
transmit a request for multi-modal configuration information; and
receive the multi-modal configuration information in response to the request.

20. A method of wireless communication performed by a user equipment (UE), comprising:
identifying multi-modal configuration information that indicates one or more of:
a multi-modal service identifier (MMSID);
a multi-modal flow group associated with the MMSID;
one or more flow-specific characteristics associated with the MMSID; or
an inter-flow synchronization associated with the MMSID; and
transmitting the multi-modal configuration information.
